(19) United States
(12) Patent Application Publication
(10) Pub. No.: US 2026/0223010 A1
(43) Pub. Date: Jul. 30, 2026

(54) APPLICATION GROUPING FOR ENERGY CONSUMPTION EXPOSURE AND ENFORCEMENT

(71) Applicant: Samsung Electronics Co., Ltd., Suwon-si (KR)

(72) Inventor: Prakash Reddy Kolan, Plano, TX (US)

(21) Appl. No.: 19/446,849

(22) Filed: Jan. 12, 2026

Related U.S. Application Data
(60) Provisional application No. 63/750,044, filed on Jan. 27, 2025.
(60) Provisional application No. 63/762,345, filed on Feb. 24, 2025.

(51) Int. Cl. H04W 52/34; H04W 24/08; H04W 24/10

(52) U.S. Cl. CPC H04W 52/34; H04W 24/08; H04W 24/10

(57) ABSTRACT

A method includes receiving, from an energy information function (EIF), group energy target information for one or more application energy groups, wherein each of the one or more application energy groups includes a plurality of applications executed by a UE, and determining, based at least in part on the group energy target information and configuration information associated with the plurality of applications, a per-application energy target for the plurality of applications, and enforcing the per-application energy target by configuring the plurality of applications to control their energy consumption not to exceed the per-application energy target. The method also includes obtaining application energy index reports from the plurality of applications, deriving, based on the application energy index reports, application group energy index information for the one or more application energy groups, and reporting the application group energy index information for the one or more application energy groups to the EIF.

### CROSS-REFERENCE TO RELATED APPLICATIONS AND CLAIM OF PRIORITY

This application claims priority under 35 U.S.C. § 119(e) to U.S. Provisional Patent Application No. 63/750,044 filed on Jan. 27, 2025, and U.S. Provisional Patent Application No. 63/762,345 filed on Feb. 24, 2025. The above-identified provisional patent applications are hereby incorporated by reference in their entirety.

### TECHNICAL FIELD

This disclosure relates generally to wireless networks. More specifically, this disclosure relates to application grouping for energy consumption exposure and enforcement.

### BACKGROUND

The use of computing technology for media processing is greatly expanding, largely due to the usability, convenience, computing power of computing devices, and the like. Portable electronic devices, such as laptops and mobile smart phones are becoming increasingly popular as a result of the devices becoming more compact, while the processing power and resources included in a given device is increasing. Even with the increase of processing power, portable electronic devices often struggle to provide the processing capabilities to handle new services and applications, as newer services and applications often require more resources than are included in a portable electronic device. Improved methods and apparatuses for configuring and deploying media processing in the network are desirable.

Cloud media processing is gaining traction where media processing workloads are setup in the network (e.g., cloud) to take advantage of benefits offered by the cloud such as (theoretically) infinite compute capacity, auto-scaling based on demand, and on-demand processing. An end user client can request a network media processing provider for provisioning and configuration of media processing functions.

### SUMMARY

This disclosure provides apparatuses and methods for application grouping for energy consumption exposure and enforcement.

In one embodiment, a method for managing energy targets for a group of applications is provided. The method includes receiving, from an energy information function (EIF), group energy target information for one or more application energy groups, wherein each of the one or more application energy groups includes a plurality of applications executed by a user equipment (UE), and determining, based at least in part on the group energy target information and configuration information associated with the plurality of applications, a per-application energy target for the plurality of applications. The method also includes enforcing the per-application energy target by configuring the plurality of applications to control their energy consumption not to exceed the per-application energy target, and obtaining application energy index reports from the plurality of applications. The method further includes deriving, based on the application energy index reports, application group energy index information for the one or more application energy groups, and reporting the application group energy index information for the one or more application energy groups to the EIF.

In another embodiment, an electronic device is provided. The electronic device includes at least one processor including processing circuitry, and memory storing instructions. The instructions, when executed by the at least one processor individually or collectively, cause the electronic device to receive, from an EIF, group energy target information for one or more application energy groups, wherein each of the one or more application energy groups includes a plurality of applications executed by the electronic device, and determine, based at least in part on the group energy target information and configuration information associated with the plurality of applications, a per-application energy target for the plurality of applications. The instructions, when executed by the at least one processor individually or collectively, also cause the electronic device to enforce the per-application energy target by configuring the plurality of applications to control their energy consumption not to exceed the per-application energy target, and obtain application energy index reports from the plurality of applications. The instructions, when executed by the at least one processor individually or collectively, further cause the electronic device to derive, based on the application energy index reports, application group energy index information for the one or more application energy groups, and report the application group energy index information for the one or more application energy groups to the EIF.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIGS. 2 and 3 illustrate example electronic devices according to embodiments of the present disclosure;

FIG. 4 illustrates an example 5GMS architecture according to embodiments of the present disclosure;

FIG. 5 illustrates an example of UE Energy Index reporting options according to embodiments of the present disclosure;

FIG. 6 illustrates an example of Application Energy Index reporting options according to embodiments of the present disclosure;

FIG. 7 illustrates an example of Application Energy Group reporting options according to embodiments of the present disclosure;

FIG. 8 illustrates an example of group energy target configuration according to embodiments of the present disclosure;

FIG. 9 illustrates an example procedure for group energy consumption enforcement according to embodiments of the present disclosure;

FIG. 10 illustrates an example procedure for application energy consumption enforcement according to embodiments of the present disclosure;

FIG. 11 illustrates an example procedure for a group energy consumption request according to embodiments of the present disclosure;

FIG. 12 illustrates an example procedure for Energy Service Directory information transfer according to embodiments of the present disclosure;

FIG. 13 illustrates another example of group energy target configuration according to embodiments of the present disclosure;

FIG. 14 illustrates another example of group energy target configuration according to embodiments of the present disclosure; and

FIG. 15 illustrates an example method for application grouping for energy consumption exposure and enforcement according to embodiments of the present disclosure.

### DETAILED DESCRIPTION

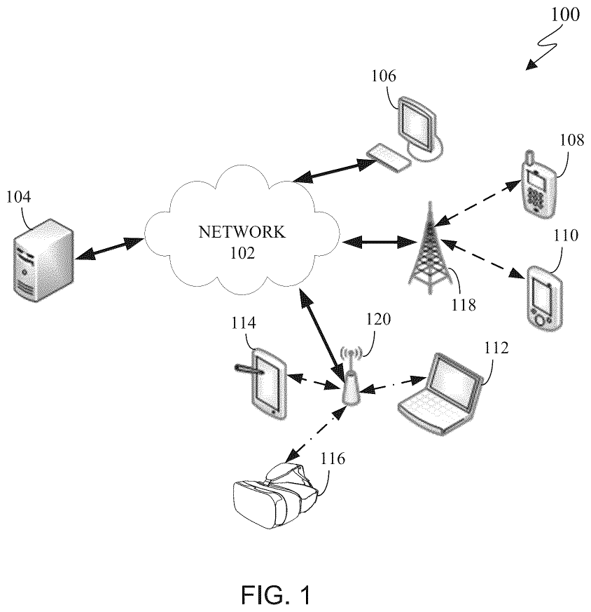

FIGS. 1 through 15, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-116. The client devices 106-116 may be, for example, a smartphone, a tablet computer, a laptop, a personal computer, a wearable device, a IMD, or the like. The server 104 can represent one or more servers. Each server 104 includes any suitable computing or processing device that can provide computing services for one or more client devices, such as the client devices 106-116. Each server 104 could, for example, include one or more processing devices, one or more memories storing instructions and data, and one or more network interfaces facilitating communication over the network 102. In certain embodiments, each server 104 can include an encoder.

Each client device 106-116 represents any suitable computing or processing device that interacts with at least one server (such as the server 104) or other computing device(s) over the network 102. The client devices 106-116 include a desktop computer 106, a mobile telephone or mobile device 108 (such as a smartphone), a PDA 110, a laptop computer 112, a tablet computer 114, and a HMD 116. However, any other or additional client devices could be used in the communication system 100. A client device may also be referred to herein as a user equipment (UE). Smartphones represent a class of mobile devices 108 that are handheld devices with mobile operating systems and integrated mobile broadband cellular network connections for voice, short message service (SMS), and Internet data communications.

In this example, some client devices 108-116 communicate indirectly with the network 102. For example, the mobile device 108 and PDA 110 communicate via one or more base stations 118, such as cellular base stations, eNodeBs (eNBs), or gNodeBs (gNBs). Also, the laptop computer 112, the tablet computer 114, and the HMD 116 communicate via one or more wireless access points 120, such as IEEE 802.11 wireless access points. Note that these are for illustration only and that each client device 106-116 could communicate directly with the network 102 or indirectly with the network 102 via any suitable intermediate device(s) or network(s).

In certain embodiments, any of the client devices 106-114 transmit information securely and efficiently to another device, such as, for example, the server 104. Also, any of the client devices 106-116 can trigger the information transmission between itself and the server 104. Any of the client devices 106-114 can function as a VR display when attached to a headset via brackets, and function similar to HMD 116. For example, the mobile device 108 when attached to a bracket system and worn over the eyes of a user can function similarly as the HMD 116. The mobile device 108 (or any other client device 106-116) can trigger the information transmission between itself and the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in the present disclosure can be used, these features could be used in any other suitable system.

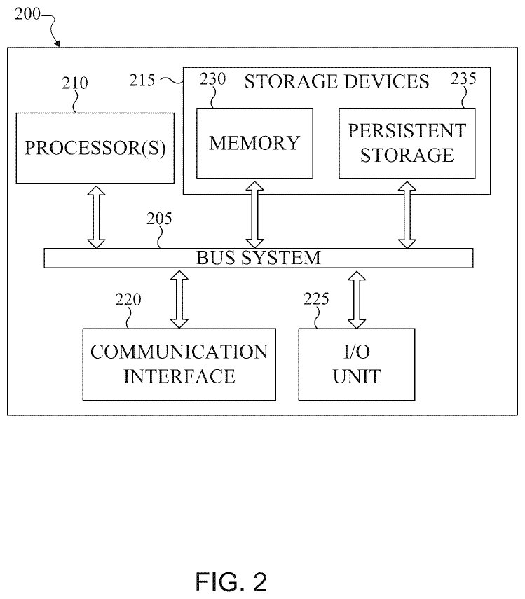

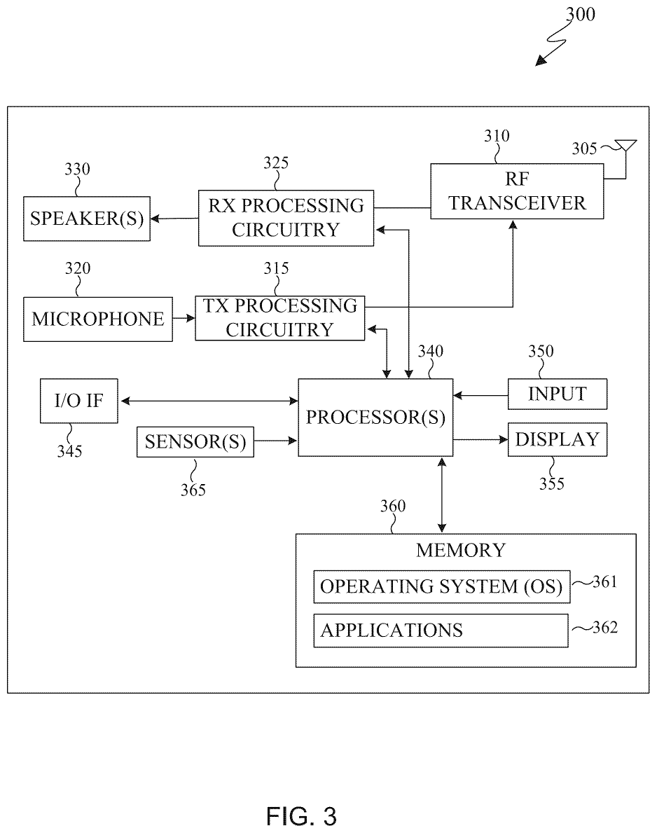

FIGS. 2 and 3 illustrate example electronic devices according to embodiments of the present disclosure. In particular, FIG. 2 illustrates an example server 200, and the server 200 could represent the server 104 in FIG. 1. The server 200 can represent one or more encoders, decoders, local servers, remote servers, clustered computers, and components that act as a single pool of seamless resources, a cloud-based server, and the like. The server 200 can be accessed by one or more of the client devices 106-116 of FIG. 1 or another server.

As shown in FIG. 2, the server 200 includes a bus system 205 that supports communication between at least one processing device (such as a processor 210), at least one storage device 215, at least one communications interface 220, and at least one input/output (I/O) unit 225.

The processor 210 executes instructions that can be stored in a memory 230. The processor 210 can include any suitable number(s) and type(s) of processors or other devices in any suitable arrangement. Example types of processors 210 include microprocessors, microcontrollers, digital signal processors, field programmable gate arrays, application specific integrated circuits, and discrete circuitry.

The memory 230 and a persistent storage 235 are examples of storage devices 215 that represent any structure(s) capable of storing and facilitating retrieval of information (such as data, program code, or other suitable information on a temporary or permanent basis). The memory 230 can represent a random access memory or any other suitable volatile or non-volatile storage device(s). The persistent storage 235 can contain one or more components or devices supporting longer-term storage of data, such as a read only memory, hard drive, Flash memory, or optical disc.

The communications interface 220 supports communications with other systems or devices. For example, the communications interface 220 could include a network interface card or a wireless transceiver facilitating communications over the network 102 of FIG. 1. The communications interface 220 can support communications through any suitable physical or wireless communication link(s). For example, the communications interface 220 can transmit a bitstream containing a 3D point cloud to another device such as one of the client devices 106-116.

The I/O unit 225 allows for input and output of data. For example, the I/O unit 225 can provide a connection for user input through a keyboard, mouse, keypad, touchscreen, or other suitable input device. The I/O unit 225 can also send output to a display, printer, or other suitable output device. Note, however, that the I/O unit 225 can be omitted, such as when I/O interactions with the server 200 occur via a network connection.

Note that while FIG. 2 is described as representing the server 104 of FIG. 1, the same or similar structure could be used in one or more of the various client devices 106-116. For example, a desktop computer 106 or a laptop computer 112 could have the same or similar structure as that shown in FIG. 2.

FIG. 3 illustrates an example electronic device 300, and the electronic device 300 could represent one or more of the client devices 106-116 in FIG. 1. The electronic device 300 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, the tablet computer 114, or the HMD 116 of FIG. 1), and the like. In certain embodiments, one or more of the client devices 106-116 of FIG. 1 can include the same or similar configuration as the electronic device 300. In certain embodiments, the electronic device 300 is an encoder, a decoder, or both. For example, the electronic device 300 is usable with data transfer, image or video compression, image or video decompression, encoding, decoding, and media rendering applications.

As shown in FIG. 3, the electronic device 300 includes an antenna 305, a radio-frequency (RF) transceiver 310, transmit (TX) processing circuitry 315, a microphone 320, and receive (RX) processing circuitry 325. The RF transceiver 310 can include, for example, a RF transceiver, a BLUETOOTH transceiver, a WI-FI transceiver, a ZIGBEE transceiver, an infrared transceiver, and various other wireless communication signals. The electronic device 300 also includes a speaker 330, a processor 340, an input/output (I/O) interface (IF) 345, an input 350, a display 355, a memory 360, and a sensor(s) 365. The memory 360 includes an operating system (OS) 361, and one or more applications 362.

The RF transceiver 310 receives, from the antenna 305, an incoming RF signal transmitted from an access point (such as a base station, WI-FI router, or BLUETOOTH device) or other device of the network 102 (such as a WI-FI, BLUETOOTH, cellular, 5G, LTE, LTE-A, WiMAX, or any other type of wireless network). The RF transceiver 310 down-converts the incoming RF signal to generate an intermediate frequency or baseband signal. The intermediate frequency or baseband signal is sent to the RX processing circuitry 325 that generates a processed baseband signal by filtering, decoding, and/or digitizing the baseband or intermediate frequency signal. The RX processing circuitry 325 transmits the processed baseband signal to the speaker 330 (such as for voice data) or to the processor 340 for further processing (such as for web browsing data).

The TX processing circuitry 315 receives analog or digital voice data from the microphone 320 or other outgoing baseband data from the processor 340. The outgoing baseband data can include web data, e-mail, or interactive video game data. The TX processing circuitry 315 encodes, multiplexes, and/or digitizes the outgoing baseband data to generate a processed baseband or intermediate frequency signal. The RF transceiver 310 receives the outgoing processed baseband or intermediate frequency signal from the TX processing circuitry 315 and up-converts the baseband or intermediate frequency signal to an RF signal that is transmitted via the antenna 305.

The processor 340 can include one or more processors or other processing devices. The processor 340 can execute instructions that are stored in the memory 360, such as the OS 361 in order to control the overall operation of the electronic device 300. For example, the processor 340 could control the reception of forward channel signals and the transmission of reverse channel signals by the RF transceiver 310, the RX processing circuitry 325, and the TX processing circuitry 315 in accordance with well-known principles. The processor 340 can include any suitable number(s) and type(s) of processors or other devices in any suitable arrangement. For example, in certain embodiments, the processor 340 includes at least one microprocessor or microcontroller. Example types of processor 340 include microprocessors, microcontrollers, digital signal processors, field programmable gate arrays, application specific integrated circuits, and discrete circuitry.

The processor 340 is also capable of executing other processes and programs resident in the memory 360, such as operations that receive and store data. The processor 340 can move data into or out of the memory 360 as required by an executing process. In certain embodiments, the processor 340 is configured to execute the one or more applications 362 based on the OS 361 or in response to signals received from external source(s) or an operator. Example, applications 362 can include an encoder, a decoder, a VR or AR application, a camera application (for still images and videos), a video phone call application, an email client, a social media client, a SMS messaging client, a virtual assistant, and the like. In certain embodiments, the processor 340 is configured to receive and transmit media content.

The processor 340 is also coupled to the I/O interface 345 that provides the electronic device 300 with the ability to connect to other devices, such as client devices 106-114. The I/O interface 345 is the communication path between these accessories and the processor 340.

The processor 340 is also coupled to the input 350 and the display 355. The operator of the electronic device 300 can use the input 350 to enter data or inputs into the electronic device 300. The input 350 can be a keyboard, touchscreen, mouse, track ball, voice input, or other device capable of acting as a user interface to allow a user in interact with the electronic device 300. For example, the input 350 can include voice recognition processing, thereby allowing a user to input a voice command. In another example, the input 350 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 350 can be associated with the sensor(s) 365 and/or a camera by providing additional input to the processor 340. In certain embodiments, the sensor 365 includes one or more inertial measurement units (IMUs) (such as accelerometers, gyroscope, and magnetometer), motion sensors, optical sensors, cameras, pressure sensors, heart rate sensors, altimeter, and the like. The input 350 can also include a control circuit. In the capacitive scheme, the input 350 can recognize touch or proximity.

The display 355 can be a liquid crystal display (LCD), light-emitting diode (LED) display, organic LED (OLED), active matrix OLED (AMOLED), or other display capable of rendering text and/or graphics, such as from websites, videos, games, images, and the like. The display 355 can be sized to fit within a HMD. The display 355 can be a singular display screen or multiple display screens capable of creating a stereoscopic display. In certain embodiments, the display 355 is a heads-up display (HUD). The display 355 can display 3D objects, such as a 3D point cloud.

The memory 360 is coupled to the processor 340. Part of the memory 360 could include a RAM, and another part of the memory 360 could include a Flash memory or other ROM. The memory 360 can include persistent storage (not shown) that represents any structure(s) capable of storing and facilitating retrieval of information (such as data, program code, and/or other suitable information). The memory 360 can contain one or more components or devices supporting longer-term storage of data, such as a read only memory, hard drive, Flash memory, or optical disc. The memory 360 also can contain media content. The media content can include various types of media such as images, videos, three-dimensional content, VR content, AR content, 3D point clouds, and the like.

The electronic device 300 further includes one or more sensors 365 that can meter a physical quantity or detect an activation state of the electronic device 300 and convert metered or detected information into an electrical signal. For example, the sensor 365 can include one or more buttons for touch input, a camera, a gesture sensor, an IMU sensors (such as a gyroscope or gyro sensor and an accelerometer), an eye tracking sensor, an air pressure sensor, a magnetic sensor or magnetometer, a grip sensor, a proximity sensor, a color sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue [RGB] sensor), and the like. The sensor 365 can further include control circuits for controlling any of the sensors included therein.

Although FIGS. 2 and 3 illustrate examples of electronic devices, various changes can be made to FIGS. 2 and 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs). In addition, as with computing and communication, electronic devices and servers can come in a wide variety of configurations, and FIGS. 2 and 3 do not limit this disclosure to any particular electronic device or server.

Next generation applications and services with varied capabilities and requirements are being studied for deployment in 5G and 5G-Advanced networks. Applications with capabilities that were not possible for older 4G and LTE networks are being investigated for deployment. The newer capabilities and inherent technologies of 5G networks such as differentiated service deployment with multi-level Quality of Service, network slicing, transmission and reception using multiple access networks etc. are driving such a demand of next generation complex application development. While the complexity of applications in next generation services have increased multifold, the hardware and software demand, network demands, and energy demands for these applications have also simultaneously increased. For successful deployment of next generation applications and services, it is not only imperative that application complexity be increased, but it is equally important that the applications be optimized and enhanced to work with lower hardware, software, and network demands.

For successful deployment of next generation applications and services with 5G and 5G-Advanced Networks, these applications and services have to be optimized when there are multiple demands. One such demand is energy, because performing complex actions and computations in these applications and services often requires an extreme amount of energy consumption to run the applications and services on end user devices and network locations. As a result of extreme carbon emissions and pollution, there has been increased awareness, and intent, from telecommunication service providers, network operators, UE device manufacturers, network equipment vendors etc. to develop hardware and software capabilities while decreasing energy requirements. Towards this effort, multiple standard organizations, academia, and enterprises have started building energy efficient architectures, products and solutions. Various embodiments of the present disclosure provide methods for energy monitoring, exposure, and enforcement to optimize energy consumption in mobile network terminal devices.

The newer 5G networks, and soon to be arriving 6G networks, are enabling development of next generation applications and services across a wide spectrum of domains and fields. Applications and services are being developed to take advantage of the capabilities of these 5G and 6G networks. Further, adaptive capabilities are being introduced into the 5G system to help these applications adapt to changing network conditions and government regulations. End to end systems in the 5G and 6G network have to interwork to enable an adaptive cellular network environment where application requirements can be optimized, and at the same time, the cost for deployment and cost of operations are reduced for the network operator.

One of the important problems being discussed and worked on right now in the world is to tackle the problem global climate change. One of the issues the operators of 5G and 6G networks are looking into to reduce the impact on global climate change is energy conservation while deploying and operating next generation cellular network applications and services. Towards these objectives, steps are being taken to actively measure energy consumption of different entities involved in application traffic for next generation applications and services. Various embodiments of the present disclosure provide methods for energy consumption measurement and providing feedback information to UE application components to help with application optimization while reducing application demands on energy.

In various embodiments of the present disclosure, a communication system such as communications system 100 may include one or more of an Application Function (AF), Access and Mobility Function (AMF), Policy Control Function (PCF), Session Management Function (SMF), and a User Plane Function (UPF). As described herein, an AF, AMF, PCF, SMF, and a UPF can be implemented in various ways, including as hardware, software, or a combination of both. In a hardware-based implementation, the above functions may include one or more processors, communication interfaces, and memory elements. The communication interfaces may include wired or wireless interfaces to facilitate data exchange with other network elements. Alternatively, the above functions can be implemented as software modules. In a software-based implementation, the above functions can comprise program instructions stored in a non-transitory computer-readable medium, such as flash memory, hard disk drives, or solid-state drives. These program instructions, when executed by one or more processors, cause the processors to perform the functions associated with the above functions.

In some embodiments, the above functions may be implemented using a combination of hardware and software. For example, certain functions may be executed by hardware components to achieve high performance, while other functions may be performed by software modules to provide flexibility and ease of updates.

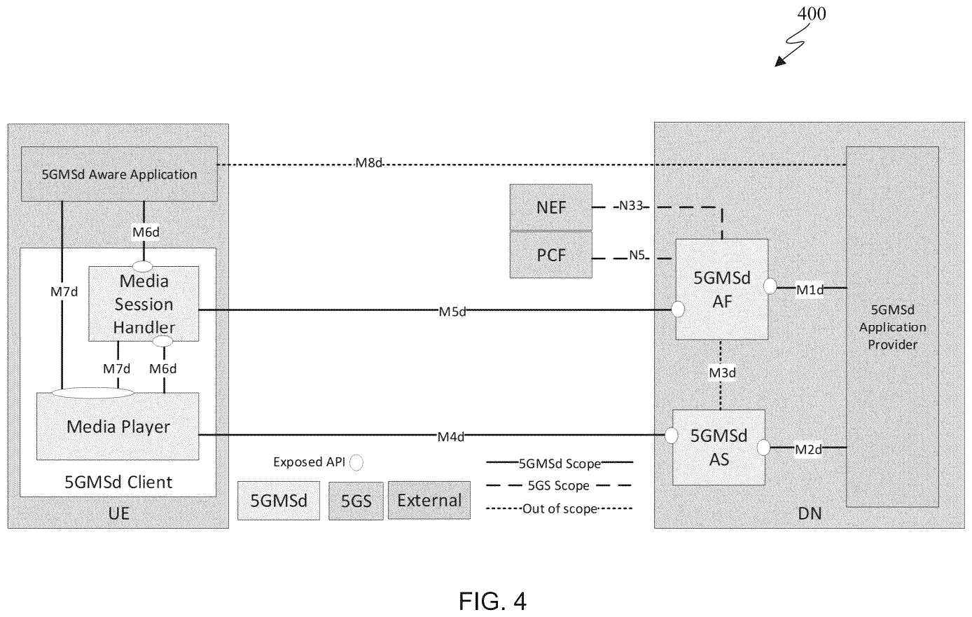

In various embodiments of the present disclosure, a communication system such as communications system 100 may be used to perform 5G Media Streaming (5GMS) based on the 5GMS architecture shown in FIG. 4.

FIG. 4 illustrates an example 5GMS architecture 400 according to embodiments of the present disclosure. The embodiment of a 5GMS architecture of FIG. 4 is for illustration only. Different embodiments of a 5GMS architecture could be used without departing from the scope of this disclosure.

In some embodiments, 5GMS architecture 400 may include one or more of the following components (some of which are not shown in FIG. 4):
5GMS AF: An Application Function dedicated to 5G Media Streaming. In the present disclosure, a 5GMS AF may also be referred to simply as an Application Function or AF. Any other generic Application Function may also be referred to herein as AF.
5GMS AS: An Application Server (AS) dedicated to 5G Media Streaming. In the present disclosure, a 5GMS AS may also be referred to simply as an Application Server or AS.
5GMS Client: A UE internal function dedicated to 5G Media Streaming. The 5GMS Client is a logical function and its sub-functions may be distributed within the UE according to implementation choice.
Media Stream Handler: A UE internal function that is part of the 5GMS Client and responsible for media stream handling functionality.
3GPP Access Node: An access network node in a 3GPP RAN (e.g., 4G LTE, 5G, NR, etc. base station such as base station 118).
Non-3GPP Access Node: An access network node that enables connectivity to a Non-3GPP access endpoint (such as wireless access point 120) to a 3GPP network (e.g., via a Non-3GPP Interworking Function [N3IWF] of a 3GPP network).
5GMS Application Provider: A service provider providing 5G media streaming services.
SMF: A Session Management Function in a 3GPP network.
UPF: A User Plane Function in 3GPP network.
5GMS ASP: An Application Service Provider (ASP) that provides 5G Media Streaming services to subscribed users using a 5GMS system. In the present disclosure, a 5GMS ASP may also be referred to simply as an Application Service Provider or ASP.

By utilizing 5GMS architecture 400, media services can be provisioned by an application service provider at a 5G AF using the M1 interface and content is ingested to a 5G AS using the M2 interface. After any processing to the ingested media (as provisioned by the application service provider and enforced by the 5G AF), the content is then distributed to end users using the M4 interface. The end user device UE uses the M5 and M4 interfaces to communicate back with the control and user plane functions (i.e., the 5G AF and 5G AS) in the core network.

Although FIG. 4 illustrates an example 5GMS architecture 400, various changes may be made to FIG. 4. For example, architecture 400 could include additional core network functions, etc. according to particular needs.

Technical publications, such as 3GPP technical report (TR) 26942 describe the study aspects of energy consumption and exposure related to media applications in 3GPP end user devices. For example, TR 26942 presents a number of studies related to collection and exposure of energy consumption information at Operations, administration, and maintenance (OAM), network function (NF), and from individual UEs (e.g., using the UE data collection, reporting and event exposure functionalities such as specified in 3GPP TS 26531 and TS 26532). TR 26942 also describes energy consumption and exposure studies and efforts in other standard forums such as ITU-T, ITU-R, MPEG, DVB, ATSC, ETSI, and for other industries such as Greening of Streaming, DIMPACT, and the Ultra HD Forum. TR 26942 specifies use cases for energy consumption reporting, and key issues and solutions related to energy information exposure, monitoring and measurement, and evaluation framework in media applications.

Different measurement collection methodologies, measurements, and parameters described in publications such as TR 26942 discussed above may be used with the collection methodologies, measurements, and parameters discussed in this disclosure.

In some embodiments, a level of energy consumption, called the Energy Index, may be specified and agreed upon by the network operator and UE manufacturers. Alternately, in some embodiments, the network operator may define a number of energy indices and share the information to the UE. For example, the network operator may use the control plane procedures specified in 3GPP TS 23501, TS 23502, and TS 23503 to share the information to the UE. Using the above methods, multiple Energy Indices may be negotiated or standardized and exchanged between the network operator and the UE. In some embodiments, each Energy Index may be specified separately, as each Energy Index may be associated with the details in Table 1.

TABLE 1
Energy Index Information

| Field | Description |
|---|---|
| Energy Source | Source of energy for the terminal (e.g., battery, wall charger, UE- |
| | to-UE supply etc.) |
| Energy Capacity | Total capacity based on the energy source (e.g., battery capacity if |
| | the energy source is a battery) |
| Energy Level | Current energy level in the UE based on type of energy source |
| | (e.g., battery level if using a battery source) |
| Average Source | Average ambient temperature. Applicable to specific energy |
| Temperature | sources such as the battery. |
| Average carbon dioxide | Amount of carbon emission (based on a measurement specified for |
| equivalent (CO2e) | the given energy level |
| emission | |
| Energy drain average | Average amount of energy drainage for a given period of time. This |
| | is dependent on the type of energy source (e.g., Energy drain |
| | average given battery source, energy drain average given wall |
| | charge energy source, etc. may be defined) |
| Energy measurement time | Amount of time during which the Energy Index report parameters |
| span | are averaged |
| Energy Consumption Rate | Rate or speed of UE charging or discharging. This may be |
| | calculated as the integral of power consumption over time |
| Carbon Intensity | In g CO₂-e/Wh. |
| | A measure of the global greenhouse gases emitted per unit of |
| | generated electricity, measured in grams of CO₂ equivalents per |
| | watt-hour. |
| Discharge rate | Calculated using Energy capacity divided by amount of time it |
| | takes to completely discharge. |

In some embodiments, the Energy Index information specified in Table 1 may be measured at a regular interval. For example, the Energy Index information may be measured at the device level or terminal level and reported using a procedure described in the present disclosure. Information about alternate Energy Indices at different levels is described later in the disclosure.

In some embodiments, an application in the UE may be pre-provisioned in the UE by the network operator or the UE manufacturer to measure the Energy Index information. Such an application may be referred to as a UE Energy Application. Any of the embodiments provided in the present disclosure may employ and/or utilize a UE Energy Application. In some embodiments, the role of a UE Energy Application as discussed in this disclosure may be performed by the 5GMS Aware Application depicted in FIG. 4.

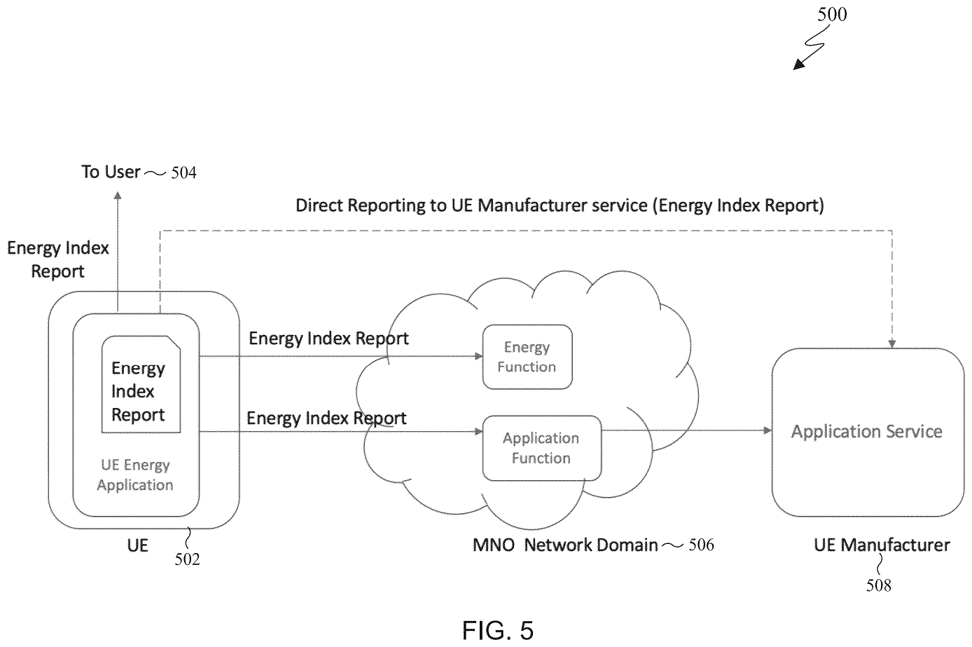

In some embodiments, Energy Index information for a UE may be reported to one or more Authorized Consumers, similar as shown in FIG. 5.

FIG. 5 illustrates an example of UE Energy Index reporting options 500 according to embodiments of the present disclosure. The embodiment of Energy Index reporting of FIG. 5 is for illustration only. Different embodiments of Energy Index reporting could be used without departing from the scope of this disclosure.

In the example of FIG. 5, a UE 502 is configured to report Energy Index information to various Authorized Consumers 504 through 508. In some embodiments, Authorized Consumers to receive the Energy Index reporting could be any of the following entities:
End user (504): The end user is the authorized consumer of the Energy Index information measured by the UE Energy Application. The end user, upon receiving this information, may infer the energy consumption and usage of the device, and may take necessary steps to conserve energy (e.g., minimize usage of the device, reduce subscription level or quality level demands etc.)
Network operator (506): The network operator may intend to know the energy consumption on the device. Based on this information, the network operator may recommend energy saving mechanisms to be adopted in the UE. In some embodiments, the network operator may provision a network function in the MNO network domain to receive an Energy Index report from the UE. The network function may be an Energy Information Function (EIF).
UE manufacturer (508): The UE manufacturer may intend to know the energy consumption on the device. Based on this information, the UE manufacturer may recommend energy saving mechanisms to be adopted in the UE. Additionally, the UE manufacturer may optimize device implementations, OS optimizations, or updates to UE Energy App to better help energy measurement and reporting processes. In some embodiments, to facilitate the exchange of Energy Index reporting to the UE manufacturer, the UE manufacturer may set up an application service inside or outside the mobile network operator (MNO) domain. An Application Function may be optionally provisioned in the network to receive the Energy Index report from the UE, which then forwards the report to the application service setup by the UE manufacturer. In some embodiments, the M5 interface may be used to report the Energy Index report to the Application Function reachable via the MNO network.

Alternatively, in some embodiments, the application service provisioned by the UE manufacturer outside the MNO network domain may receive direct reporting of Energy Index report without going through the MNO network. In this case, a secure tunnel may be established between the UE Energy App in the UE and the application service setup by the UE manufacturer. In this case, the Energy Index report is securely transferred from the UE Energy App in UE to application service setup by the UE manufacturer. Optionally, the UE Energy App may use Non-3GPP network interfaces (e.g., WIFI) to securely transmit the Energy Index Report to the application service setup by the UE manufacturer.

Although FIG. 5 illustrates one example of Energy Index reporting options 500, various changes may be made to FIG. 5. For example, various changes to Authorized Consumers could be made, various changes to the reporting mechanisms could be made, etc. according to particular needs.

In some embodiments, based on Energy Index information, an Application Energy Index may be additionally specified or negotiated between the network operator and the UE. The Application Energy Index may be associated with the information in Table 2:

TABLE 2
Application Energy Index Information

| Field | Description |
|---|---|
| App Name | Name of the application |
| App Id | Unique Identifier to this application |
| App Package | Information about application package (e.g., based on application store |
| Information | details) |
| Prime Energy Index | The Energy Index information (e.g., as shown in Table 1) given the |
| for app | primary usage of this application. All the Energy Index information |
| | values here correspond to the case when only this application is running |
| | on the UE (including just the essential applications that are necessary to |
| | run this application.) |
| Application Energy | Energy Index report information (e.g., as described regarding FIG. 5) |
| Index Report | associated with this application. |

In some embodiments, the Application Energy Index information specified in Table 2 may be provided for each Application installed on the UE.

In some embodiments, an application developer may use Operating System (OS) application programming interfaces (APIs) to obtain information about Energy Index parameters associated with the application on a regular basis. In embodiments such as these, the frequency with which the application uses the OS APIs to get Energy Index parameters for the application may be specified by the network operator, service provider, or the User using the UE.

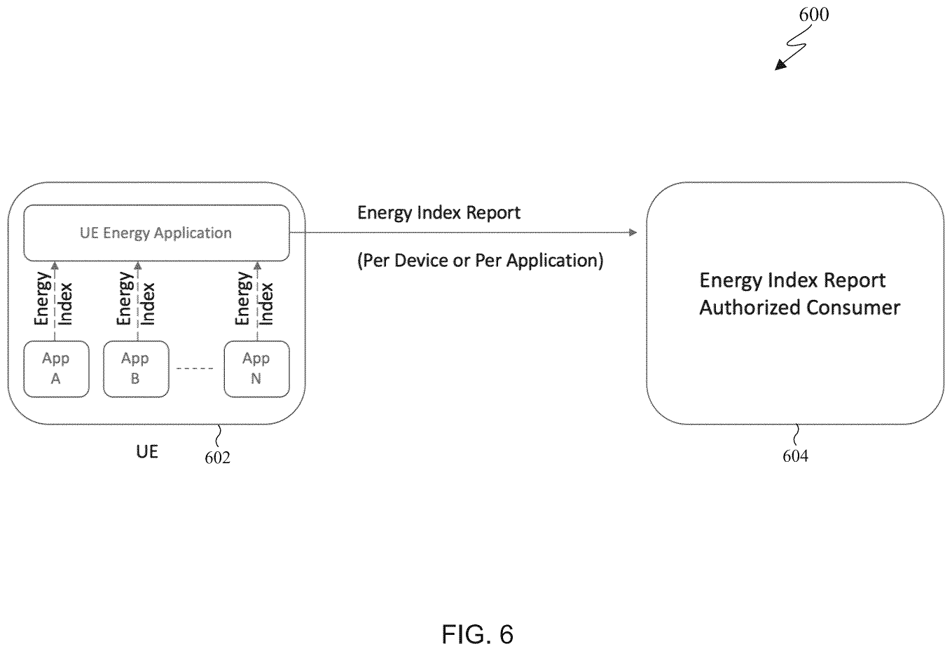

In some embodiments, Application Energy Index information may be reported to one or more Authorized Consumers, similar as shown in FIG. 6.

FIG. 6 illustrates an example of Application Energy Index reporting options 600 according to embodiments of the present disclosure. The embodiment of Application Energy Index reporting of FIG. 6 is for illustration only. Different embodiments of Application Energy Index reporting could be used without departing from the scope of this disclosure.

In the example of FIG. 6, a UE 602 is configured to report Application Energy Index information for Applications A through N to various Authorized Consumers 604, similarly as described regarding FIG. 5. For example, the Authorized Consumers 604 could be any of an end user, network operator, or UE manufacturer, and the reports could be reported using the same interfaces as described regarding FIG. 5. The Application Energy Index information may be reported on a per device or per application basis.

Although FIG. 6 illustrates one example of Application Energy Index reporting options 600, various changes may be made to FIG. 6. For example, various changes to Authorized Consumers could be made, various changes to the reporting mechanisms could be made, etc. according to particular needs.

In some embodiments, based on Energy Index and Application Energy Index values, a set of applications may be grouped to form an Application Energy Group. In embodiments such as these, each group may be constituted by multiple applications. Each application in this group may be associated with an Application Energy Index similar as described regarding FIG. 6. The Application Energy group may be associated with the information in Table 3.

TABLE 3
Application Energy Group Information

| Field | Description |
|---|---|
| Group Name | Name of Application Energy Group |
| Group Id | Unique Identifier of this group |
| Group Type | Type of application grouping. See e.g., Table 4. |
| Group Creator | Creator of the application group - any of the authorized consumers |
| | such as the end user, network operator, UE manufacturer |
| Group Requirements | Requirements based on which this application grouping is created. |
| | The authorized consumers may define the grouping based on any of: |
| | Application type: Grouping is primarily based on type of |
| | applications |
| | Service Level Agreement (SLA) requirements: Grouping is |
| | based on SLA requirements. Applications with similar SLA |
| | requirements may be grouped together |
| | Energy requirements: Applications with similar energy |
| | requirements may be grouped together |
| Application List | List of Application Energy Indices. Each member of this list is the |
| | Application Energy Index (e.g., as described regarding Table 2 and |
| | FIG. 6) information for a given application. |
| | Applications may be added and/or removed by the authorized |
| | consumers on demand into this group. Following configuration |
| | options may be additionally specified by the authorized consumers |
| | while defining this application grouping: |
| | Membership interval: Amount of time the application list |
| | member is a part of this group before its membership expires |
| | Application priority: Priority of application within the group. |
| | The group with highest priority in the group has the highest |
| | chance of having the energy consumption or energy |
| | expectations realized. Application priority may be based on: |
| | Type applications - e.g., based on modality (audio applications |
| | may have higher priority compared to video applications) |
| | Application SLA - Applications with higher SLA |
| | requirements have higher priority compared to |
| | applications with or no SLA requirements |
| | Energy requirements - Certain applications with |
| | lower energy requirements may have higher priority |
| | than applications with higher energy requirements - |
| | for example, application serving low energy sensors. |
| | However, depending on other information such as |
| | application type and SLA requirements, certain |
| | applications with higher energy requirements may |
| | have higher priority compared to applications with |
| | lower energy requirements. |
| Average Energy Level | Average energy level in the UE given the Energy Index information |
| | of all the applications in the group. The Energy level of each |
| | application in the group is taken into consideration to compute the |
| | average energy level of the group |
| Group Average CO2e | Average amount of carbon emission in the UE given the Energy Index |
| emission | information of each application in the group. The carbon emission of |
| | each application in the group is taken into consideration to compute |
| | the average carbon emission of the group |
| Group Average Energy | Average amount of energy drainage for a given period of time in the |
| drain | UE given the Energy Index Information of each application in the |
| | group. The Energy drain of each application in the group is taken into |
| | consideration to compute the average energy drain of the group |
| Group Average Energy | Average energy consumption rate across all applications in the group. |
| Consumption Rate | |
| Carbon Intensity | Average carbon intensity across all applications in the group. |
| Discharge rate | Average discharge rate across all applications in the group. |

In some embodiments, any of the network operator, the service provider, or the user may configure Application Energy Groups in the UE.

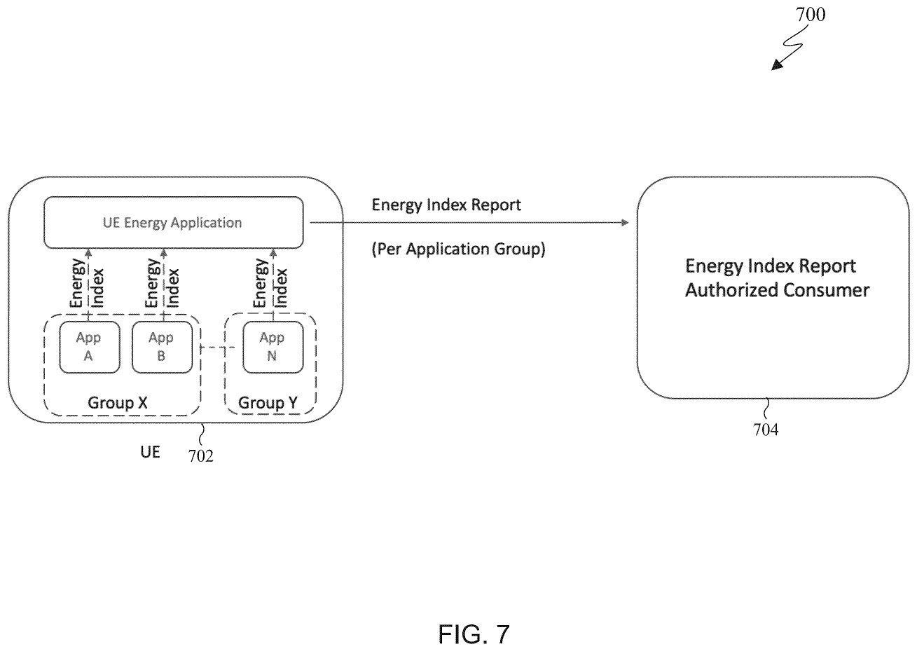

In some embodiments, Application Energy Group information may be reported to one or more Authorized Consumers, similar as shown in FIG. 7.

FIG. 7 illustrates an example of Application Energy Group reporting options 700 according to embodiments of the present disclosure. The embodiment of Application Energy Group reporting of FIG. 7 is for illustration only. Different embodiments of Application Energy Group reporting could be used without departing from the scope of this disclosure.

In the example of FIG. 7, a UE 702 is configured to report Application Energy Group information for Applications Energy Groups X (which includes Applications A through B) through Y (which includes Application N) to various Authorized Consumers 704, similarly as described regarding FIG. 5. For example, the Authorized Consumers 704 could be any of an end user, network operator, or UE manufacturer, and the reports could be reported using the same interfaces as described regarding FIG. 5. The Application Energy Group information may be reported on a per Application Energy Group basis.

Although FIG. 7 illustrates one example of Application Energy Group reporting options 700, various changes may be made to FIG. 7. For example, various changes to Authorized Consumers could be made, various changes to the reporting mechanisms could be made, etc. according to particular needs.

In some embodiments, the group membership of an application may be dependent upon multiple factors and defined/provisioned/configured by the any of the authorized consumers such as the end user, network operator, and UE manufacturer. In embodiments such as these, such an application grouping may be performed using any of the grouping options shown in Table 4. Each of the groups in Table 4 inherit properties from the Application Energy Structure described regarding Tables 1 through 3 and FIGS. 5 through 7.

TABLE 4
Application Energy Grouping Options

| | | Provisioned/configured by |
|---|---|---|
| | | any of the authorized |
| Grouping | Description | consumers |
| Ad hoc Application | A grouping of an ad hoc set of | End user, network operator, UE |
| Energy Groups | applications on the UE. | manufacturer |
| Network Operator | Applications exclusive to the network | Network operator |
| Application Energy | operator may be grouped into an | |
| Group | application group. | |
| | The network operator may update the list | |
| | of applications in this grouping, for | |
| | example using the M5 interface. | |
| Profile based groups | Grouping based on profiles installed on | Network operator, UE |
| | the UE device. For example, different | manufacturer, End user |
| | profiles in the UE such as the personal | |
| | profile, enterprise profile etc. may have a | |
| | different application grouping. The | |
| | Application Energy Index information of | |
| | all applications installed in the profile are | |
| | taken into consideration in this grouping. | |

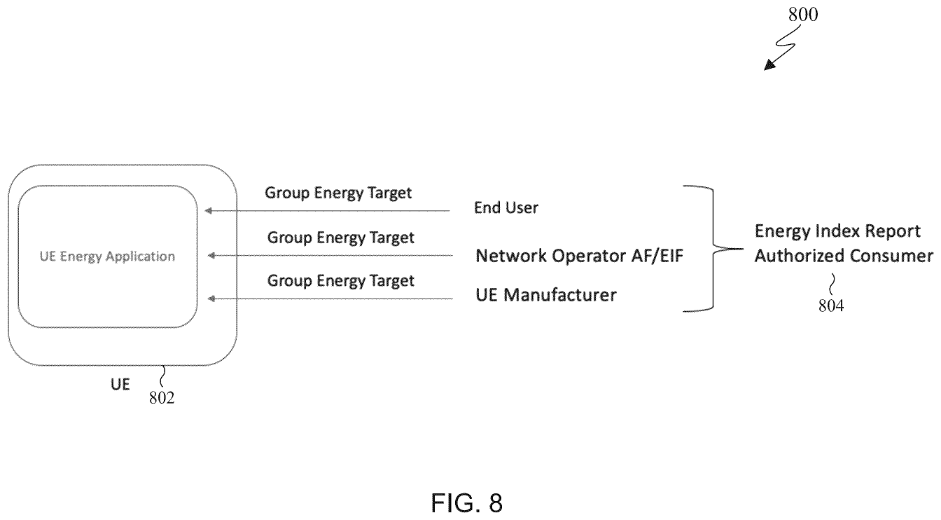

In some embodiments, the authorized consumers of Energy Index reports may configure group energy targets for application energy groups or individual applications within the UE Energy Application similarly as shown in FIG. 8.

FIG. 8 illustrates an example of group energy target configuration 800 according to embodiments of the present disclosure. The embodiment of group energy target configuration of FIG. 8 is for illustration only. Different embodiments of group energy target configuration could be used without departing from the scope of this disclosure.

In the example of FIG. 8, a UE 802 is configured to receive group energy targets from various Authorized Consumers 804, similarly as described regarding FIG. 5. For example, the Authorized Consumers 804 could be any of an end user, network operator, or UE manufacturer, and the group energy targets could be received using the same interfaces as described regarding FIG. 5. The group energy targets represent the target for energy consumption with all the applications in that group. In some embodiments, the total energy consumption of all the applications in the group is to not exceed the configured/provisioned group energy targets.

Although FIG. 8 illustrates one example of group energy target configuration 800, various changes may be made to FIG. 8. For example, various changes to Authorized Consumers could be made, various changes to the communication mechanisms could be made, etc. according to particular needs.

In some embodiments, a group energy target may be associated with the information shown in Table 5.

TABLE 5
Group Energy Target Information

| Information Element | Description |
|---|---|
| Group Name | Name of the application grouping to which this energy target applies |
| Group Id | The identifier of the application grouping to which this energy target |
| | applies |
| Group target | Energy consumption requirements as a whole to all the member |
| | applications in the group. The following may be provided as part of |
| | this group target information: |
| | Total Group Energy Level: Total amount of energy level |
| | attributed to all the applications in this group. The UE |
| | Energy Application takes this into account to manage the |
| | energy consumption of each individual application so as not |
| | to exceed the total energy level for the whole group based |
| | on individual application consumption |
| | Total CO2e emission: Total amount of carbon emission for |
| | all the applications in this group. The UE Energy |
| | Application takes this into account to manage the carbon |
| | emission of each individual application so as not to exceed |
| | the total carbon emission for the whole group based on |
| | individual application carbon emission |
| | Total Carbon Intensity: Total amount of carbon intensity for |
| | all applications in this group. The UE Energy Application |
| | takes this into account to manage the carbon intensity of |
| | each individual application so as not to exceed the total |
| | carbon intensity for the whole group based on individual |
| | application carbon intensity. |
| Group Application Targets | The authorized consumer may optionally include individual |
| | application energy targets in addition to/instead of group targets. To |
| | do so, the authorized consumers may include a list of application |
| | energy targets. Each member in this list is an application energy |
| | target with the following information: |
| | Group Name: Name of group to which this application |
| | belongs to |
| | Group Id: The identifier of the group to which this |
| | application belongs to |
| | Application Energy Level: Energy level attributed to this |
| | application in this group. The UE Energy Application takes |
| | this into account to manage the energy consumption of this |
| | application to not to exceed the application energy level |
| | target |
| | Application CO2e emission target: Carbon emission target |
| | attributed to this application in this group. The UE Energy |
| | Application takes this into account to manage the carbon |
| | emission of this application to not to exceed the application |
| | carbon emission target |
| | Application Carbon Intensity target: Carbon intensity target |
| | attributed to this application in this group. The UE Energy |
| | Application takes this into account to manage the carbon |
| | intensity of this application to not to exceed the application |
| | carbon intensity target. |

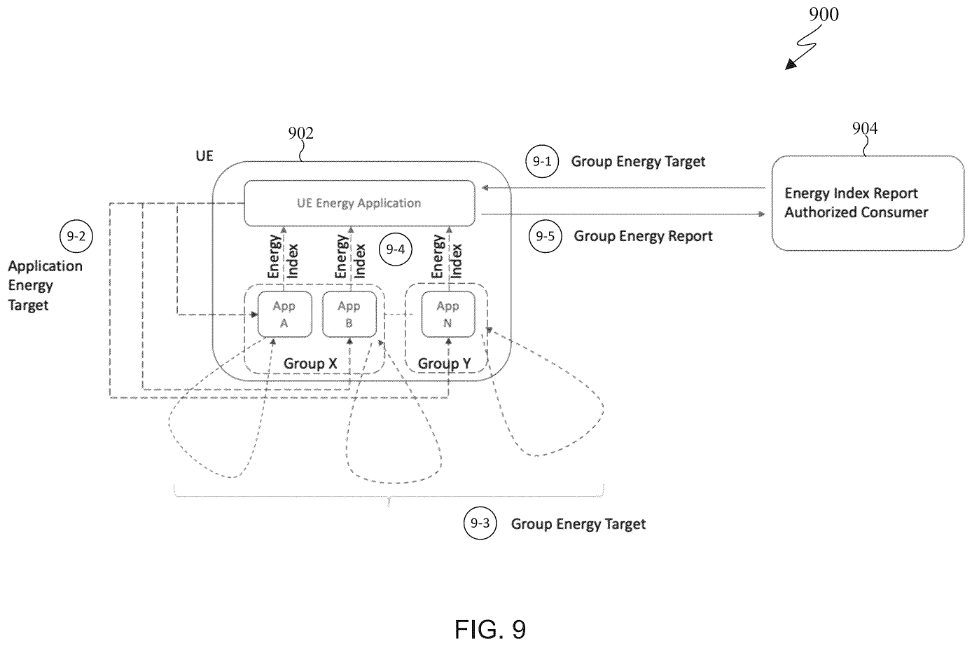

In some embodiments, based on Application Energy Index reports and Application Group Energy reports and group energy targets, an energy consumption enforcement procedure may be adopted by a UE to help with energy consumption and conservation, similar as shown in FIG. 9.

FIG. 9 illustrates an example procedure for group energy consumption enforcement 900 according to embodiments of the present disclosure. An embodiment of the procedure illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a procedure for group energy consumption enforcement could be used without departing from the scope of this disclosure.

In the example of FIG. 9, a UE 902 is in communication with one or more authorized consumers 904, similarly as described regarding FIGS. 5 through 8. Procedure 900 begins at operation 9-1. At operation 9-1, the one or more authorized consumers 904 provisions or configures group energy target(s), similarly as described regarding FIG. 8. The group energy target(s) may have overall group level energy targets, or target information of each individual application in the application group similarly as described in Table 5.

At operation 9-2, upon receiving the group energy targets from the authorized consumers, if the group targets indicate the overall group energy targets, a UE Energy Application of the UE 902 may infer individual application energy targets based on application configuration/provisioning information available at UE 902's disposal. Alternatively, if the group targets indicate individual energy targets for each application separately, the UE Energy Application may use the target information directly to configure each of the individual applications in the group. The UE Energy Application may use information such as application priority, application SLA requirements, application energy requirements, application type etc. to determine the energy targets of individual applications. The application energy targets for each application are then configured/provisioned by the UE Energy Application at each of the individual applications.

At operation 9-3, based on the configured application energy targets, individual applications attempt to consume energy according to the requested target and not exceed the target.

At operation 9-4, the individual applications, from time to time, report application energy index information to the UE Energy Application.

At operation 9-5, the UE Energy Application, upon receiving the individual application energy reports, collects all the information, derives group level energy index information, and shares this information with the authorized consumers.

Although FIG. 9 illustrates one example procedure for group energy consumption enforcement 900, various changes may be made to FIG. 9. For example, while shown as a series of operations, various operations in FIG. 9 could overlap, occur in parallel, occur in a different order, occur any number of times, be omitted, or replaced by other operations.

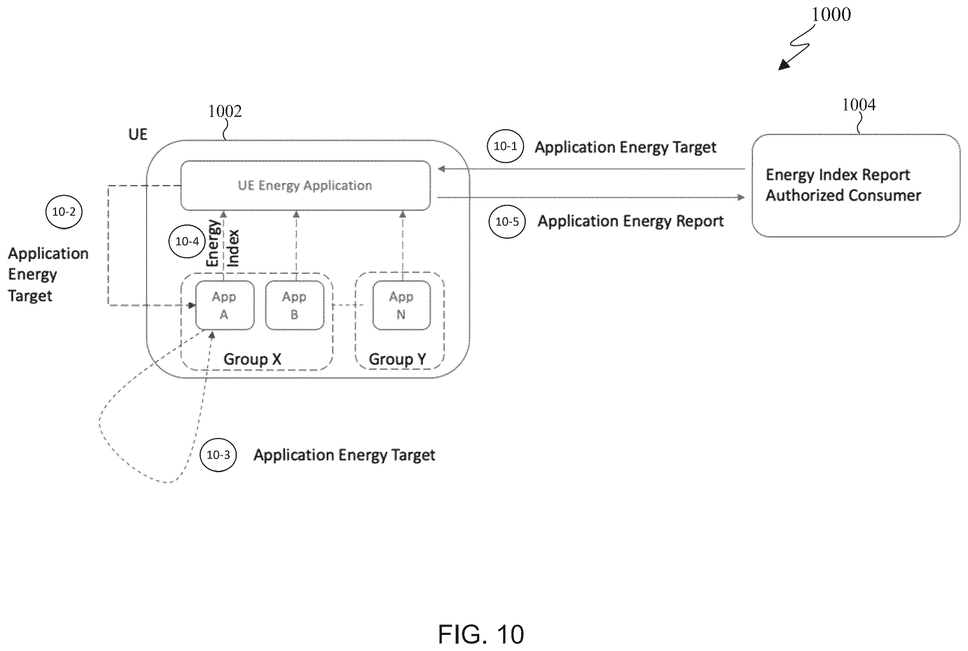

In some embodiments, based on Application Energy Index reports and Application Group Energy reports and group energy targets, an application energy consumption enforcement procedure may be enforced by authorized consumers to help with energy consumption and conservation, similar as shown in FIG. 10.

FIG. 10 illustrates an example procedure for application energy consumption enforcement 1000 according to embodiments of the present disclosure. An embodiment of the procedure illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a procedure for application energy consumption enforcement could be used without departing from the scope of this disclosure.

In the example of FIG. 10, a UE 1002 is in communication with one or more authorized consumers 1004, similarly as described regarding FIGS. 5 through 8. Procedure 1000 begins at operation 10-1. At operation 10-1, the one or more authorized consumers 904 provisions or configures application energy target(s), similarly as described regarding operation 9-1 of FIG. 9.

At operation 10-2, upon receiving the application energy targets from the authorized consumers, a UE Energy Application of the UE 1002 may infer individual application energy targets based on application configuration/provisioning information available at UE 1002's disposal. The UE Energy Application may use information such as application priority, application SLA requirements, application energy requirements, application type etc. to determine the energy target of the application. The application energy target for the application is then configured/provisioned by the UE Energy Application at the application.

At operation 10-3, based on the configured application energy target, the application attempts to consume energy according to the requested target and not exceed the target.

At operation 10-4, as per the reporting configuration, the application reports application energy index information to the UE Energy Application.

At operation 10-5, the UE Energy Application, upon receiving the application energy reports, shares this information with the authorized consumers.

Although FIG. 10 illustrates one example procedure for application energy consumption enforcement 1000, various changes may be made to FIG. 10. For example, while shown as a series of operations, various operations in FIG. 10 could overlap, occur in parallel, occur in a different order, occur any number of times, be omitted, or replaced by other operations.

In some embodiments, when the Energy Function provides a group application energy target, the energy target for each individual application group may be computed using an Energy Allocation percentage for the application. In embodiments such as these, the energy application target for the application may be computed using the below formula:

$$ET {[}_{App i} ] = \frac{E {T}_{[ App Group ]}}{{AllocationPercentage}_{App i}}$$

where:
ET [_{App i}] is the Energy Target of Application I;
ET [_{App Group}] is the Energy Target of Application Group; and
AllocationPercentage_{App i} is the Energy Allocation Percentage of App i within the Application group.

In some embodiments, the Application percentage of each application in the application group may be configured by the network operator, UE manufacturer, or the end user.

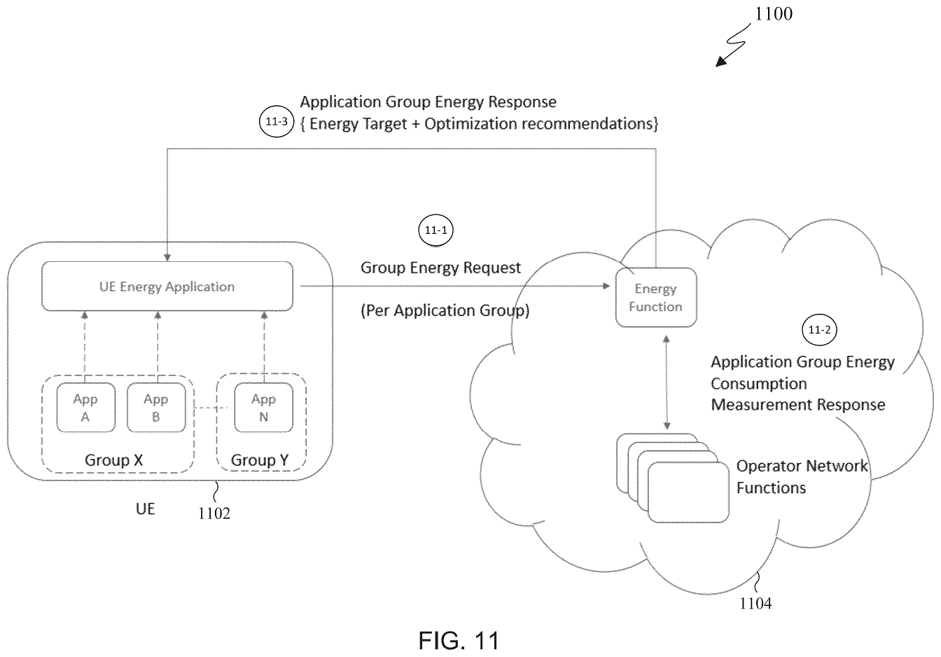

In some embodiments, the UE Energy Application may request the Energy Information Function (EIF) in the operator network to provide updated group energy targets and any optional optimization recommendations for optimizing energy consumption of different applications that are part of a specific group, similar as shown in FIG. 11.

FIG. 11 illustrates an example procedure for a group energy consumption request 1100 according to embodiments of the present disclosure. An embodiment of the procedure illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a procedure for a group energy consumption request could be used without departing from the scope of this disclosure.

In the example of FIG. 11, a UE 1102 is in communication with a network 1104 of an authorized consumer (i.e., an operator network), similarly as described regarding FIGS. 5 through 8. In the example of FIG. 11, it is assumed that one or more Application Energy groups are defined in the UE 1102. Procedure 1100 begins at operation 11-1. At operation 11-1, a UE Energy Application in the UE 1102 infers or possesses an Energy Index report for each application in each of the application groups X through Y. The UE Energy Application sends a group energy request (per application group) to an Energy Information Function in the network 1104 to request updated energy targets and recommendations for optimizing energy consumption of different applications in the group.

At operation 11-2, the Energy Information Function in the network 1104 receives the request from the UE Energy Application, and extracts different applications that are part of each application energy group. The Energy Information Function perform the following steps for each application in each application group:
a. Use existing mechanisms to request the data volume of the application at different network functions in the operator network. The data volume of the applications can be fetched in downlink and uplink directions at gNB, UPF, and at the Application Functions
b. Use the same procedure from step a to get the data volume for each individual flow of the application
c. Fetch the data volume for all applications of the UE at each of the above network functions
d. Fetch the total data volume for all UEs going through each of the above network functions

The EIF may then compute the energy consumption at each of the above network functions for each of the different granularities (UE level, application level, flow level) using existing procedures.

The EIF may also then infer the energy consumption of the application groups as follows:

$${Energy}_{[ App Group ]} = {\sum }_{i = 1}^{n} {E}_{i}$$

where Ei is the energy consumption of Application I in the App group.

Based on the computed Energy consumption of each application in the application group, and that of the overall application group, the EIF then derives the energy target for the application group based on application service provider configuration and user preferences.

Based on the derived Energy target of the application group, the EIF then derives the Energy Target for each of the applications in the application group as described herein.

At step 11-3, the EIF informs the Energy Target for each Application group and the Energy Target for each of the applications inside the application groups to the UE Energy Applications inside the UE.

Along with the information of group application energy targets to the UE Energy Application, the Energy Information Function may include one of the following recommendations from Table 6 to optimize the performance of the application group in the UE.

TABLE 6
Performance Optimization Recommendations

| Recommendation | Description |
|---|---|
| Move Application from current group to another | The Energy Information Function may |
| application group | recommend moving one or more applications |
| | from current application group to another |
| | application group to optimize the performance |
| | of remaining applications in the group. |
| | The Energy Information Function provides the |
| | application identification information of one or |
| | more applications it recommends to be moved |
| | out of the current group. The Energy |
| | Information provides the group identification of |
| | destination application group these applications |
| | have to be moved to |
| | The Energy Information may provide the time- |
| | period parameter in this table if it intends that |
| | such a move of one or more applications is only |
| | beneficial if it is applicable to a specific time |
| | period. |
| Move Application from another group to current | The Energy Information Function may infer that |
| application group | moving an application from a different |
| | application group may help with realizing |
| | energy targets if it is moved to current |
| | application group. |
| | The Energy Information Function may |
| | recommend moving one or more applications |
| | from a different application group to current |
| | application group to optimize the performance |
| | of applications in the current group. |
| | The Energy Information Function provides the |
| | application identification information of one or |
| | more applications it recommends to be moved |
| | into the current group. The Energy Information |
| | provides the group identification of destination |
| | application group from which these applications |
| | have to be moved from |
| | The Energy Information may provide the time- |
| | period parameter in this table if it intends that |
| | such a move of one or more applications is only |
| | beneficial if it is applicable to a specific time |
| | period. |
| Time-period | Amount of time the applications have to be |
| | moved into or moved from. |

Although FIG. 11 illustrates one example procedure for a group energy consumption request 1100, various changes may be made to FIG. 11. For example, while shown as a series of operations, various operations in FIG. 11 could overlap, occur in parallel, occur in a different order, occur any number of times, be omitted, or replaced by other operations.

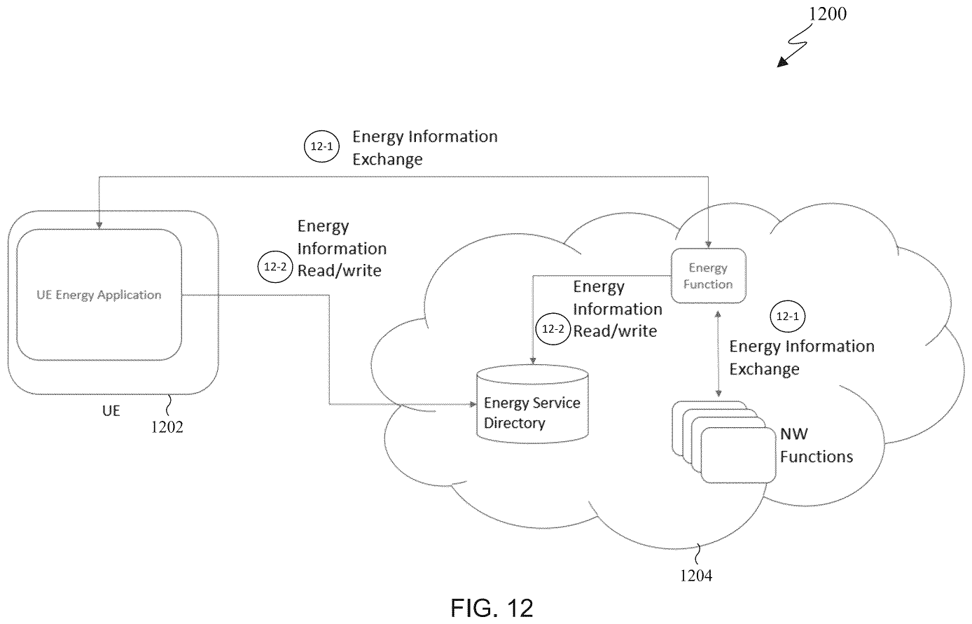

In some embodiments, different types of information about energy may be persist in an Energy Service Directory. In embodiments such as these, network functions and UE functionalities that take part in energy management using different procedures as described herein may read, write, or update any energy information to the Energy Service Directory similar as shown in FIG. 12.

FIG. 12 illustrates an example procedure for Energy Service Directory information transfer 1200 according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a procedure for Energy Service Directory information transfer could be used without departing from the scope of this disclosure.

In the example of FIG. 12, a UE 1202 is in communication with a network 1204 of an authorized consumer (i.e., an operator network), similarly as described regarding FIGS. 5 through 8. Procedure 1202 begins at operation 12-1. At operation 12-1, an E of the network 1204 exchanges energy information with one or more of a UE energy application of the UE 1202 and/or one or more network functions of the network 1204.

At operation 12-2, One or more of the EIF and/or the UE application function read and/or write energy information to an energy service directory of the network 1204.

In the example of FIG. 12, the energy service directory may persist any energy-related information from any of the entities as shown in Table 7.

TABLE 7
Energy Service Directory Information

| Information Source | Type of information |
|---|---|
| UE | UE Energy Application may read or write (upon proper authorization) |
| | into the Energy Service Directory. Information about the following |
| | may be read/written/updated in the Energy Service Directory: |
| | Energy consumption given all the applications installed in the |
| | UE. |
| | Energy consumption information of each application in the |
| | UE |
| | Energy consumption information of each application flow for |
| | each application in the UE |
| | Energy consumption information of each PDU Session |
| | associated with each application in the UE |
| | Energy consumption information of each media type (e.g., |
| | audio/video/haptics/tactile etc.) for each application in the |
| | UE |
| | Energy information about each of the different types of |
| | information described in this table for each of the different |
| | network slices and/or data networks used. In this case, |
| | network slice information and DNN information is |
| | read/written/updated in the energy service directory. |
| | Energy information for each application group configured by |
| | any of the authorized entities such as the end user, network |
| | operator, UE manufacturer etc. The energy information for |
| | each application group may in turn have different types of |
| | energy -related information described in this disclosure |
| | All the above information may be available separately for uplink and |
| | downlink. |
| Any of the network | Any of the Network Functions in the operator network may read or |
| functions in the | write energy information (upon proper authorization) into the Energy |
| operator network | Service Directory. Information about the following may be |
| | read/written/updated in the Energy Service Directory: |
| | Energy consumption information of the Network Function |
| | given all the processing and traffic flowing through the |
| | Network Function. |
| | Energy consumption information for each application from |
| | each of the UEs |
| | Energy consumption information given each application flow |
| | for each application from each of the UEs |
| | Energy consumption information of each PDU Session |
| | associated with each application from each UE |
| | Energy consumption information of each media type (e.g., |
| | audio/video/haptics/tactile etc.) for each application from |
| | each UE |
| | Energy information about each of the different types of |
| | information described in this table for each of the different |
| | network slices and/or data networks used. In this case, |
| | network slice information and DNN information is |
| | read/written/updated in the energy service directory. |
| | Energy information for each application group configured by |
| | any of the authorized entities such as the end user, network |
| | operator, UE manufacturer etc. for each of the UEs. The |
| | energy information for each application group for each UE |
| | may in turn have different types of energy -related |
| | information described in this disclosure |
| | All the above information may be available separately for uplink and |
| | downlink. |
| Application Service or | Any of the Application Service/Application Servers may read or write |
| Application Server | energy information (upon proper authorization) into the Energy |
| | Service Directory. Information about the following may be |
| | read/written/updated in the Energy Service Directory: |
| | Energy consumption information of the Application |
| | Service/Application Server given all the processing and |
| | traffic flowing through the Application Service/Application |
| | Server. |
| | Energy consumption information for each application from |
| | each of the UEs terminating at the Application |
| | Service/Application Server |
| | Energy consumption information given each application flow |
| | for each application from each of the UEs terminating at the |
| | Application Service/Application Server |
| | Energy consumption information of each transport session |
| | associated with each application from each UE terminating at |
| | the Application Service/Application Server |
| | Energy consumption information of each media type (e.g., |
| | audio/video/haptics/tactile etc.) for each application from |
| | each UE terminating at the Application Service/Application |
| | Server |
| | Energy information about each of the different types of |
| | information described in this table for each of the different |
| | network slices and/or data networks used. In this case, |
| | network slice information and DNN information is |
| | read/written/updated in the energy service directory. |
| | Energy information for each application group configured by |
| | any of the authorized entities such as the end user, network |
| | operator, UE manufacturer etc. for each of the UEs |
| | terminating at the Application Service/Application Server. |
| | The energy information for each application group for each |
| | UE may in turn have different types of energy -related |
| | information described in this disclosure |
| | All the above information may be available separately for uplink and |
| | downlink. |

The energy information described in the present disclosure and the example of FIG. 12 may be retrieved and persisted in the Energy service directory at any of the frequencies described in Table 8 by each of the entities shown in Table 8.

TABLE 8
Energy Service Directory Information Frequency of Retrieval and/or Persistence

| Energy Information | |
|---|---|
| source | Frequency of retrieval and/or persistence into Energy Service Directory |
| UE | The end user or the network operator or the UE manufacturer may define |
| | a UE energy reporting interval. At the expiry of this interval, or at the |
| | defined frequency, the energy information related to the UE described |
| | earlier in the disclosure is retrieved and persisted to the Energy Service |
| | Directory. |
| | The different types of energy information from the UE described in this |
| | disclosure may be persisted into the Energy Service Directory according |
| | to different procedures described in this disclosure. |
| Network Functions | The network operator may define a Network Function energy reporting |
| | interval. At the expiry of this interval, or at the defined frequency, the |
| | energy information related to the Network Function and/or the UE |
| | traffic going through the NF described earlier in the disclosure is |
| | retrieved and persisted to the Energy Service Directory. |
| | The different types of energy information from the Network Functions |
| | described in this disclosure may be persisted into the Energy Service |
| | Directory according to different procedures described in this disclosure. |
| Application | The network operator or the Application Service Provider may define |
| Service/Server | an Application Service/Application Server energy reporting interval. At |
| | the expiry of this interval, or at the defined frequency, the energy |
| | information related to the Application Service/Application Server |
| | described earlier in the disclosure is retrieved and persisted to the |
| | Energy Service Directory. |
| | The different types of energy information from the Application |
| | Service/Application Server described in this disclosure may be persisted |
| | into the Energy Service Directory according to different procedures |
| | described in this disclosure. |

Although FIG. 12 illustrates one example procedure for Energy Service Directory information transfer 1200, various changes may be made to FIG. 12. For example, while shown as a series of operations, various operations in FIG. 12 could overlap, occur in parallel, occur in a different order, occur any number of times, be omitted, or replaced by other operations.

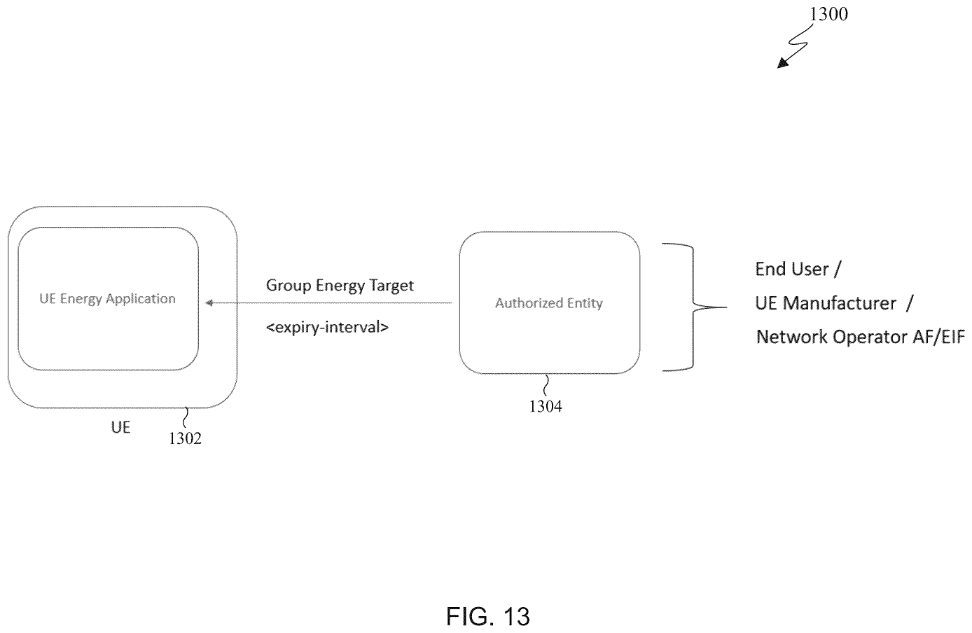

As described earlier herein, in some embodiments, application group energy targets from an Energy Function are provided to a UE Energy Application in a UE, which are then divided and individually allocated to each application in the UE based on a parameter AllocationPercentage assigned to the application by any of the authorized entities such as the end user, UE manufacturer, network operator, and/or application service/application server. Alternatively, in some embodiments, the application group energy target may be limited to a certain amount of time, and the energy function may send updated application group energy target information to the UE Energy Application in the UE, similar as shown in FIG. 13.

FIG. 13 illustrates another example of group energy target configuration 1300 according to embodiments of the present disclosure. The embodiment of group energy target configuration of FIG. 13 is for illustration only. Different embodiments of group energy target configuration could be used without departing from the scope of this disclosure.

In the example of FIG. 13, a UE 1302 is configured to receive group energy targets from various Authorized Consumers 1304, similarly as described regarding FIG. 5. For example, the Authorized Consumers 1304 could be any of an end user, network operator, or UE manufacturer, and the group energy targets could be received using the same interfaces as described regarding FIG. 5. The group energy targets represent the target for energy consumption with all the applications in that group. In some embodiments, the total energy consumption of all the applications in the group is to not exceed the configured/provisioned group energy targets.

In some embodiments, an EIF of an authorized consumer 1304 may also include an “expiry-interval” along with the application group energy target. The expiry-interval may represent the amount of time for which the provided application group energy target is applicable. The Energy Information Function sends an updated application group energy target to a UE Energy Application of the UE 1302 before the expiry of this interval. If for any reason, the updated application group energy target does not reach the UE Energy Application before the expiry of this interval, the applicability of energy targets for the application group expire, and are no longer applicable. In this case, the UE Energy Application waits to hear back from the Energy Information Function to receive an application group energy target. The Energy Information Function may avoid sending the application group energy target to the UE Energy Application if it intends that the application group in the UE no longer needs to follow the application group energy targets.

Although FIG. 13 illustrates one example of group energy target configuration 1300, various changes may be made to FIG. 13. For example, various changes to Authorized Consumers could be made, various changes to the communication mechanisms could be made, etc. according to particular needs.

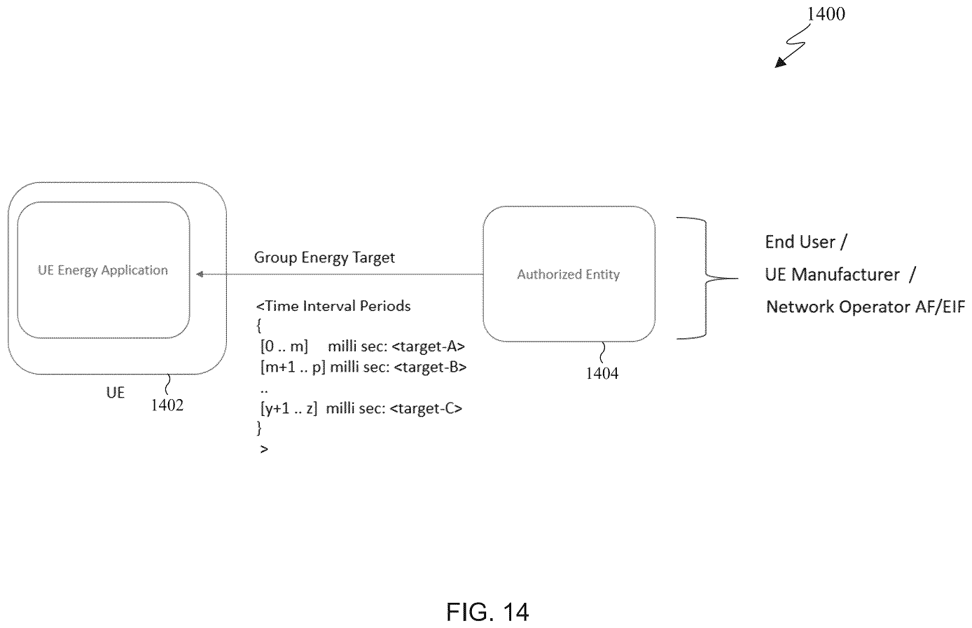

As described earlier herein, in some embodiments, an Energy Information Function may send an application group energy target for a specific time period, and the EIF may update the energy target before expiry of a time interval. Alternatively, in some embodiments, the Energy Information Function may generate application group energy targets for a number of time periods and provide this information to the UE Energy Application in the UE, similar as shown in FIG. 14.

FIG. 14 illustrates another example of group energy target configuration 1400 according to embodiments of the present disclosure. The embodiment of group energy target configuration of FIG. 14 is for illustration only. Different embodiments of group energy target configuration could be used without departing from the scope of this disclosure.

In the example of FIG. 14, a UE 1402 is configured to receive group energy targets from various Authorized Consumers 1404, similarly as described regarding FIG. 5. For example, the Authorized Consumers 1404 could be any of an end user, network operator, or UE manufacturer, and the group energy targets could be received using the same interfaces as described regarding FIG. 5. The group energy targets represent the target for energy consumption with all the applications in that group. In some embodiments, the total energy consumption of all the applications in the group is to not exceed the configured/provisioned group energy targets.

In some embodiments an EIF of an authorized consumer 1404 may send the information in Table 9 to a UE Energy Application of the UE 1402 to indicate application group energy targets over multiple time periods:

TABLE 9
Energy Target Time Periods

| Time Period | Application Group Energy Target |
|---|---|
| [0 − m] milli seconds | <application group energy target information A> |
| [m + 1 − p] milli seconds | <application group energy target information B> |
| . . . | . . . |
| [y + 1 − z] milli seconds | <application group energy target information C> |

In some embodiments, the information in Table 9 may be provided by the Energy Information Function to the UE Energy Application to request for energy targets for different time periods.

In some embodiments, the time periods in Table 9 may not be uniformly distributed. In embodiments such as these, it is up to the network operator, Application Function, Energy Information Function, etc. to specify the duration of each time period.

In some embodiments, the Energy Information Function may send updated application group energy target information for a range of time periods as described in the example of FIG. 14.

Although FIG. 14 illustrates one example of group energy target configuration 1400, various changes may be made to FIG. 14. For example, various changes to Authorized Consumers could be made, various changes to the communication mechanisms could be made, etc. according to particular needs.

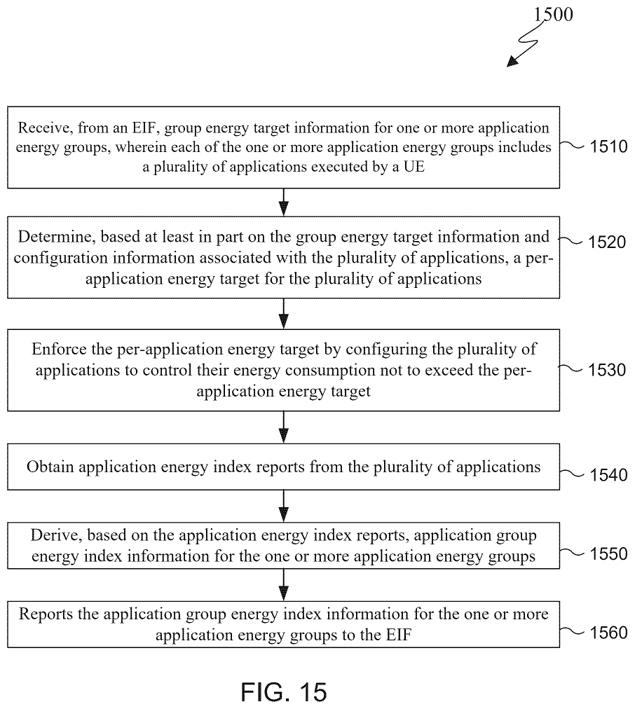

FIG. 15 illustrates an example method for application grouping for energy consumption exposure and enforcement 1500 according to embodiments of the present disclosure. An embodiment of the method illustrated in FIG. 15 is for illustration only. One or more of the components illustrated in FIG. 15 may be implemented in specialized circuitry configured to perform the noted functions or one or more of the components may be implemented by one or more processors executing instructions to perform the noted functions. Other embodiments of a method for application grouping for energy consumption exposure and enforcement could be used without departing from the scope of this disclosure.

In the example of FIG. 15, method 1500 an electronic device (such as one of the UEs 502-1302 of FIGS. 5-13), receiving, from an EIF, group energy target information for one or more application energy groups. Each of the one or more application energy groups includes a plurality of applications executed by the electronic device (e.g., a UE) (1510).

The electronic device then determines, based at least in part on the group energy target information and configuration information associated with the plurality of applications, a per-application energy target for the plurality of applications (1520).

The electronic device then enforces the per-application energy target by configuring the plurality of applications to control their energy consumption not to exceed the per-application energy target (1530).

The electronic device then obtains application energy index reports from the plurality of applications (1540).

The electronic device then derives, based on the application energy index reports, application group energy index information for the one or more application energy groups (1550).

The electronic device then reports the application group energy index information for the one or more application energy groups to the EIF (1560).

Although FIG. 15 illustrates one example method for application grouping for energy consumption exposure and enforcement 1500, various changes may be made to FIG. 15. For example, while shown as a series of steps, various steps in FIG. 15 could overlap, occur in parallel, occur in a different order, occur any number of times, be omitted, or replaced by other steps.

In some embodiments, the electronic device may receive an update of at least one of the group energy target information or the per-application energy target, and a membership of the one or more application energy groups. In response to the receiving the update, the electronic device may derive updated application group energy index information for the one or more application energy groups, and report the updated application group energy index information for the one or more application energy groups to the EIF.

In some embodiments, the application energy index reports may be based on an application energy index that represents at least one of an energy source, average CO2e emission, average energy drain, energy consumption rate, carbon intensity, and discharge rate, and the application energy index may indicate a prime energy index corresponding to a case when only essential applications are running on the electronic device to support running an application associated with a respective application energy report.

In some embodiments, at least one of the energy source, average CO2e emission, average energy drain, energy consumption rate, carbon intensity, and discharge rate may be determined according to one or more reporting levels. For example, the reporting levels may be similar as shown in Table 7.

In some embodiments, to determine the per-application energy target, the electronic device may configure the per-application energy target using an allocation percentage for each of the plurality of applications in the plurality of applications in the application energy group, and determine the per-application energy target according to a relation of a form per-application energy target=group energy target information×allocation percentage for the application in the application energy group.

In some embodiments, to enforce the per application energy target, the electronic device may receive a recommendation to move at least one application from a current application energy group to another application energy group, and update a membership of the application energy groups based on the recommendation. The recommendation may include an identification of the at least one application, an identification of a destination application energy group, and a time period associated with the move.

In some embodiments, each of the plurality of applications may be included in a respective application energy group based on at least one of a set of group requirements that include at least one of (i) type of application, (ii) application SLA requirement, and (iii) energy requirements, and each of the applications included in a respective application energy group is associated with (i) a membership interval, and (ii) an application priority.

In some embodiments, to report the application group energy index information for the one or more application energy groups to the EIF, the electronic device may forward the application energy index reports received from the plurality of applications to the EIF.

In some embodiments, the electronic device may generate, based on the application group energy index information for the one or more application energy groups, a respective group energy report for each of the one or more application energy groups. In embodiments such as these, to report the application group energy index information for the one or more application energy groups to the EIF, the electronic device may transmit to the EIF the respective group energy report for each of the one or more application energy groups.

In some embodiments, the electronic device may transmit, to the EIF, one or more group energy requests for recommendations for optimizing energy consumption of different applications in the one or more application energy groups, and receive, for each of the one or more group energy requests, a corresponding optimization recommendation.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A method for managing energy targets for a group of applications, the method comprising:
receiving, from an energy information function (EIF), group energy target information for one or more application energy groups, wherein each of the one or more application energy groups includes a plurality of applications executed by a user equipment (UE);
determining, based at least in part on the group energy target information and configuration information associated with the plurality of applications, a per-application energy target for the plurality of applications;
enforcing the per-application energy target by configuring the plurality of applications to control their energy consumption not to exceed the per-application energy target;
obtaining application energy index reports from the plurality of applications;
deriving, based on the application energy index reports, application group energy index information for the one or more application energy groups; and
reporting the application group energy index information for the one or more application energy groups to the EIF.

2. The method of claim 1, further comprising:
receiving an update of at least one of:
the group energy target information or the per-application energy target; and
a membership of the one or more application energy groups; and
in response to receiving the update:
deriving updated application group energy index information for the one or more application energy groups; and
reporting the updated application group energy index information for the one or more application energy groups to the EIF.

3. The method of claim 1, wherein:
the application energy index reports are based on an application energy index that represents at least one of an energy source, average carbon dioxide equivalent (CO2e) emission, average energy drain, energy consumption rate, carbon intensity, and discharge rate; and
the application energy index indicates a prime energy index corresponding to a case when only essential applications are running on the UE to support running an application associated with a respective application energy index report.

4. The method of claim 3, wherein:
at least one of the energy source, average CO2e emission, average energy drain, energy consumption rate, carbon intensity, and discharge rate are determined according to one or more reporting levels; and
the one or more reporting levels include at least one of:
reporting for all the applications installed in the UE;
reporting for each application in the UE;
reporting for each application flow for each application in the UE;
reporting for each media type for each application in the UE; and
reporting for each of different network slices and/or data networks used by each application in the UE.

5. The method of claim 1, wherein determining the per-application energy target comprises:
configuring the per-application energy target using an allocation percentage for each of the applications in the plurality of applications in the application energy group; and
$$determining the per - application energy target according \\ to a relation of a form per - application energy target = group energy target information \times allocation percentage for the application in the application energy group .$$

6. The method of claim 1, wherein enforcing the per-application energy target comprises:
receiving a recommendation to move at least one application from a current application energy group to another application energy group, wherein the recommendation includes an identification of the at least one application, an identification of a destination application energy group, and a time period associated with the move, and
updating a membership of the application energy groups based on the recommendation.

7. The method of claim 1, wherein each of the plurality of applications is included in a respective application energy group based on at least one of a set of group requirements that include at least one of (i) type of application, (ii) application service level agreement (SLA) requirements, and (iii) energy requirements; and
each of the applications included in a respective application energy group is associated with (i) a membership interval, and (ii) an application priority.

8. The method of claim 1, wherein reporting the application group energy index information for the one or more application energy groups to the EIF comprises forwarding the application energy index reports received from the plurality of applications to the EIF.

9. The method of claim 1, further comprising generating, based on the application group energy index information for the one or more application energy groups, a respective group energy report for each of the one or more application energy groups,
wherein reporting the application group energy index information for the one or more application energy groups to the EIF comprises transmitting to the EIF the respective group energy report for each of the one or more application energy groups.

10. The method of claim 1, further comprising:
transmitting, to the EIF, one or more group energy requests for recommendations for optimizing energy consumption of different applications in the one or more application energy groups; and
receiving, for each of the one or more group energy requests, a corresponding optimization recommendation.

11. An electronic device comprising:
at least one processor including processing circuitry; and
memory storing instructions, wherein the instructions, when executed by the at least one processor individually or collectively, cause the electronic device to:
receive, from an energy information function (EIF), group energy target information for one or more application energy groups, wherein each of the one or more application energy groups includes a plurality of applications executed by the electronic device;
determine, based at least in part on the group energy target information and configuration information associated with the plurality of applications, a per-application energy target for the plurality of applications;
enforce the per-application energy target by configuring the plurality of applications to control their energy consumption not to exceed the per-application energy target;
obtain application energy index reports from the plurality of applications;
derive, based on the application energy index reports, application group energy index information for the one or more application energy groups; and
report the application group energy index information for the one or more application energy groups to the EIF.

12. The electronic device of claim 11, wherein the instructions, when executed by the at least one processor individually or collectively, further cause the electronic device to:
receive an update of at least one of:
the group energy target information or the per-application energy target; and
a membership of the one or more application energy groups; and
in response to receipt of the update:
derive updated application group energy index information for the one or more application energy groups; and
report the updated application group energy index information for the one or more application energy groups to the EIF.

13. The electronic device of claim 11, wherein:
the application energy index reports are based on an application energy index that represents at least one of an energy source, average carbon dioxide equivalent (CO2e) emission, average energy drain, energy consumption rate, carbon intensity, and discharge rate; and
the application energy index indicates a prime energy index corresponding to a case when only essential applications are running on the electronic device to support running an application associated with a respective application energy report.

14. The electronic device of claim 13, wherein:
at least one of the energy source, average CO2e emission, average energy drain, energy consumption rate, carbon intensity, and discharge rate are determined according to one or more reporting levels; and
the one or more reporting levels include at least one of:
reporting for all the applications installed in the electronic device;
reporting for each application in the electronic device;
reporting for each application flow for each application in the electronic device;
reporting for each media type for each application in the electronic device; and
reporting for each of different network slices and/or data networks used by each application in the electronic device.

15. The electronic device of claim 11, wherein to determine the per-application energy target, the instructions, when executed by the at least one processor individually or collectively, cause the electronic device to:
configure the per-application energy target using an allocation percentage for each of the plurality of applications in the plurality of applications in the application energy group; and
determine the per-application energy target according to a relation of a form per-application energy target=group energy target information×allocation percentage for the application in the application energy group.

16. The electronic device of claim 11, wherein to enforce the per-application energy target, the instructions, when executed by the at least one processor individually or collectively, cause the electronic device to:
receive a recommendation to move at least one application from a current application energy group to another application energy group, wherein the recommendation includes an identification of the at least one application, an identification of a destination application energy group, and a time period associated with the move, and
update a membership of the application energy groups based on the recommendation.

17. The electronic device of claim 11, wherein each of the plurality of applications is included in a respective application energy group based on at least one of a set of group requirements that include at least one of (i) type of application, (ii) application service level agreement (SLA) requirements, and (iii) energy requirement; and
each of the applications included in a respective application energy group is associated with (i) a membership interval, and (ii) an application priority.

18. The electronic device of claim 11, wherein to report the application group energy index information for the one or more application energy groups to the EIF, the instructions, when executed by the at least one processor individually or collectively, cause the electronic device to forward the application energy index reports received from the plurality of applications to the EIF.

19. The electronic device of claim 11, wherein:
the instructions, when executed by the at least one processor individually or collectively, further cause the electronic device to generate, based on the application group energy index information for the one or more application energy groups, a respective group energy report for each of the one or more application energy groups, and
to report the application group energy index information for the one or more application energy groups to the EIF, the instructions, when executed by the at least one processor individually or collectively, cause the electronic device to transmit to the EIF the respective group energy report for each of the one or more application energy groups.

20. The electronic device of claim 11, wherein the instructions, when executed by the at least one processor individually or collectively, cause the electronic device to:
transmit, to the EIF, one or more group energy requests for recommendations for optimizing energy consumption of different applications in the one or more application energy groups; and
receive, for each of the one or more group energy requests, a corresponding optimization recommendation.
